(19) United States
(12) Patent Application Publication
(10) Pub. No.: US 2023/0167955 A1
(43) Pub. Date: Jun. 1, 2023

(54) WATER LAMP STORAGE TABLE

(71) Applicant: CHIN-SHENG YANG, Tainan City (TW)

(72) Inventor: CHIN-SHENG YANG, Tainan City (TW)

(21) Appl. No.: 17/574,557

(22) Filed: Jan. 13, 2022

(30) Foreign Application Priority Data
Nov. 22, 2021 (CN) 202122866539.3

(51) Int. Cl. F21S 6/00; F21S 10/00

(52) U.S. Cl. CPC F21S 6/002; F21S 10/002

(57) ABSTRACT

The disclosure discloses a water lamp storage table, including: a water lamp body with a light transmissive three-dimensional shape, the water lamp body being filled with flowable liquid; a connecting base connected to the water lamp body, an electronic control unit being disposed inside the connecting base; a storage platform, connected to the water lamp body or the connecting base, and used for placing items; and a rotating component, connected to the electronic control unit, and used for agitating the liquid inside the water lamp body for flowing. According to the disclosure, the storage platform is connected to the water lamp body or the connecting base, to place items. In addition, the water lamp body is filled with the flowable liquid, and the electronic control unit is disposed in the connecting base.

### CROSS-REFERENCE TO RELATED APPLICATION

This application claims the benefit of China Patent Application No. 202122866539.3, filed on 22 Nov. 2021, which is hereby incorporated by reference for all purposes as if fully set forth herein.

### BACKGROUND

### Technical Field

The disclosure relates to the field of item placing technologies, and in particular, to a water lamp storage table.

### Related Art

With the continuous improvement of people’s living standards, there are more and more increasingly small daily necessities, such as keys, mobile phones, and Bluetooth headsets. Many times, people are very worried about how to place these items. Sometimes, the items are placed in a mess, and it is relatively troublesome to find them when they need to be used. Therefore, storage platforms have been more and more widely used in family life, and are very useful for placing daily items. The key is that the items can be easily accessed without laborious search. However, conventional storage platforms are relatively simple in design, and have a single function, namely, can only be used for placing items.

The creator has been engaged in the manufacturing industry of water lamp craftwork for a long time, and has applied for an approved U.S. Pat. No. US 7762682 B2. In addition, the creator also conducts multifaceted examination and research on storage platforms. The creator combines the patent with a storage platform, to further conceive and design a new storage table structure. Therefore, the disclosure comes into being.

### SUMMARY

An objective of the disclosure is to provide a water lamp storage table with a simple structure and multi-functionality.

To resolve the above technical problem, the disclosure is achieved by the following technical solutions.

A water lamp storage table comprises:
a water lamp body with a light transmissive three-dimensional shape, the water lamp body being filled with flowable liquid;
a connecting base connected to the water lamp body, an electronic control unit being disposed inside the connecting base;
a storage platform, connected to the water lamp body or the connecting base, and used for placing items; and
a rotating component, connected to the electronic control unit, and used for agitating the liquid inside the water lamp body for flowing.

In an embodiment, when the storage platform is connected to the water lamp body, the connecting base is located at the bottom of the water lamp body, and the storage platform is located at the top of the water lamp body.

In an embodiment, when the storage platform is connected to the connecting base, the storage platform is located on a side of the connecting base.

In an embodiment, the storage platform has an accommodation portion with an opening facing upward or an opening facing a side.

In an embodiment, the water lamp body comprises a hollow housing and a bottom cover, and the bottom cover covers the bottom of the hollow housing, so that an enclosed space is formed inside the hollow housing, and the enclosed space is filled with the flowable liquid.

In an embodiment, the rotating component comprises a magnetic moving member, a magnetic rotating shaft, and a power member, the magnetic moving member is disposed in the enclosed space and located at the bottom of the water lamp body, the magnetic rotating shaft and the power member are connected to each other and are separately located in the connecting base, and the power member is electrically connected to the electronic control unit; and

the power member drives the magnetic rotating shaft to rotate, and under a rotating state of the magnetic rotating shaft, the magnetic moving member rotates after being adsorbed by the magnetic rotating shaft, to agitate the liquid in the enclosed space to make the liquid flow.

In an embodiment, a light emitting unit is further disposed in the connecting base, and is electrically connected to the electronic control unit.

In an embodiment, the connecting base has a switch electrically connected to the electronic control unit.

In an embodiment, glittering powders are added into the flowable liquid.

The disclosure has the following beneficial effects: according to the water lamp storage table of the disclosure, the storage platform is connected to the water lamp body or the connecting base, to place items. In addition, the water lamp body is filled with the flowable liquid, and the electronic control unit is disposed in the connecting base. The electronic control unit supplies power to the rotating component to make the rotating component work, thereby agitating the liquid in the water lamp body to make the liquid flow. Finally, when items are placed on the water lamp storage table, ornamental value can be improved, functionality of the water lamp storage table is enhanced, and interestingness of the water lamp storage table can be improved.

### BRIEF DESCRIPTION OF THE DRAWINGS

FIG. 1 is a schematic structural diagram of Embodiment 1 of a water lamp storage table of the disclosure;

FIG. 2 is a cross-sectional view of Embodiment 1 of the water lamp storage table of the disclosure; and

FIG. 3 is a schematic structural diagram of Embodiment 2 of a water lamp storage table of the disclosure.

As shown in the accompanying drawing: 100: water lamp body; 110: hollow housing; 120: bottom cover; 200: connecting base; 300: storage platform; 310: accommodation portion; 400: rotating component; 410: magnetic moving member; 420: magnetic rotating shaft; 430: power member; 500: light emitting unit; and 600: switch.

### DETAILED DESCRIPTION

To make the foregoing objects, features and advantages of the disclosure more comprehensible, detailed description is made to specific implementations of the disclosure below with reference to the accompanying drawings. In the following description, many specific details are described to give a full understanding of the disclosure. However, the disclosure may be implemented in many other manners different from those described herein. A person skilled in the art may make similar improvements without departing from the connotation of the disclosure. Therefore, the disclosure is not limited to the specific embodiments disclosed below.

### Embodiment 1

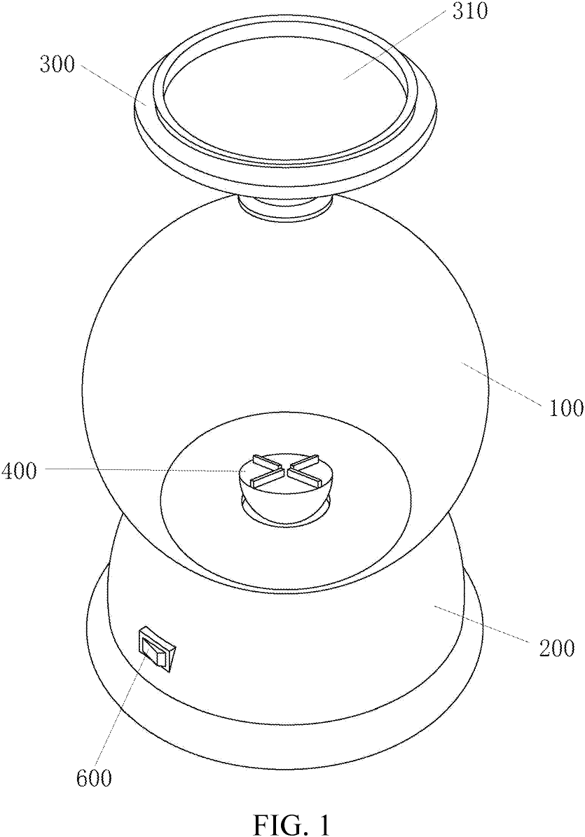

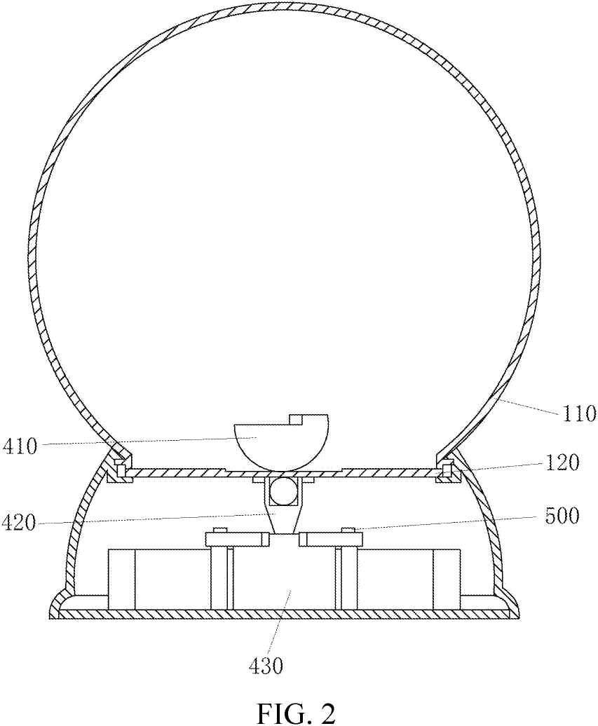

Referring to FIG. 1 and FIG. 2, a water lamp storage table includes:
a water lamp body 100 with a light transmissive three-dimensional shape, the water lamp body 100 being filled with flowable liquid;
a connecting base 200 connected to the water lamp body 100, an electronic control unit being disposed inside the connecting base 200;
a storage platform 300, connected to the water lamp body 100 or the connecting base 200, and used for placing items; and
a rotating component 400, connected to the electronic control unit, and used for agitating the liquid inside the water lamp body 100 for flowing.

Specifically, the water lamp storage table of this embodiment has a simple structure and few assembly components, and mainly includes the water lamp body 100, the connecting base 200, the storage platform 300, and the rotating component 400. When the above components are assembled, the connecting base 200 is connected to the bottom of the water lamp body 100, the storage platform 300 is mounted at the top of the water lamp body 100, and the water lamp body 100 is filled with liquid. In addition, an electronic control unit is disposed inside the connecting base 200, and a switch 600 is disposed on an outer wall of the connecting base 200. The rotating component 400 is connected to the electronic control unit, and the switch 600 is activated, so that the electronic control unit energizes the rotating component 400 to work, thereby agitating the liquid in the water lamp body 100 through the rotating component 400 to make the liquid flow. Finally, a function of placing items is realized through the storage platform 300. In addition, the liquid inside the water lamp body 100 flows, which improves interestingness and ornamental value of the water lamp storage table, so that functionality of the water lamp storage table is increased.

To facilitate placement of items, an accommodation portion 310 with an opening facing upward is disposed on the storage platform 300. The accommodation portion 310 can prevent items placed on the storage platform 300 from falling. Certainly, the accommodation portion 310 may alternatively be disposed on a side of the storage platform 300, and is shaped like a bookshelf.

In addition, to make the water lamp body 100 have a simple structure, the water lamp body 100 includes a hollow housing 110 and a bottom cover 120, and the bottom cover 120 covers the bottom of the hollow housing 110, so that an enclosed space is formed inside the hollow housing 110, and the enclosed space is filled with the flowable liquid.

Referring to FIG. 2, to improve the interestingness and ornamental value of the water lamp storage table, the liquid inside the hollow housing 110 needs to be agitated. Therefore, the rotating component 400 of this embodiment includes a magnetic moving member 410, a magnetic rotating shaft 420, and a power member 430, the magnetic moving member 410 is disposed in the enclosed space and located at the bottom of the water lamp body 100, the magnetic rotating shaft 420 and the power member 430 are connected to each other and are separately located in the connecting base 200, and the power member 430 is electrically connected to the electronic control unit.

After the switch 600 is activated, the power member 430 is energized to work. The power member 430 may be a motor, and the power member 430 drives the magnetic rotating shaft 420 to rotate. Under a rotating state of the magnetic rotating shaft 420, due to magnetic action, the magnetic moving member 410 disposed at the bottom of the water lamp body 100 rotates after being adsorbed by the magnetic rotating shaft, to agitate the liquid in the enclosed space through the magnetic moving member 410 to make the liquid flow, thereby improving the functionality, interestingness, and ornamental value of the water lamp storage table.

Certainly, to make the interestingness and ornamental value better, a light emitting unit 500 is further disposed in the connecting base 200, the light emitting unit 500 includes a plurality of LED lamps, and is electrically connected to the electronic control unit. In addition, glittering powders are added into the flowable liquid. The electronic control unit makes the light emitting unit 500 emit light, to illuminate the liquid in the water lamp body 100. After being refracted by the glittering powders in the liquid, the projected light is colorful and dazzling, thereby improving the interestingness and ornamental value of the water lamp storage table. Even if the water lamp storage table is in poor light, items can still be conveniently and quickly taken.

### Embodiment 2

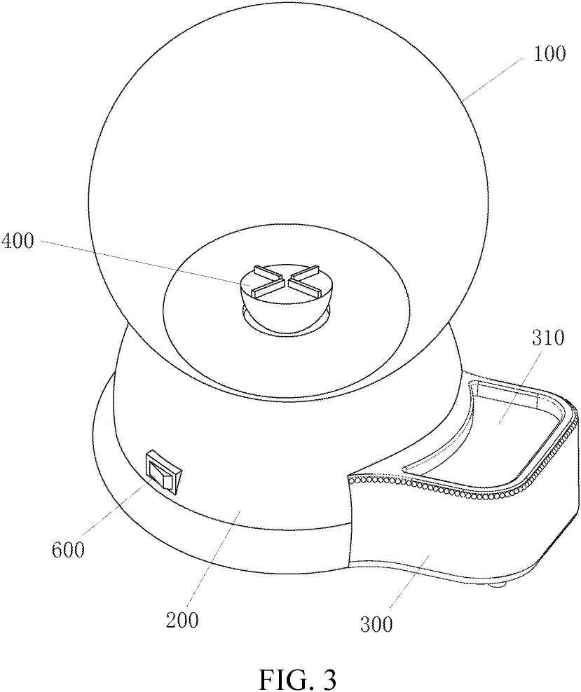

Referring to FIG. 3, a water lamp storage table in this embodiment is basically the same as the water lamp storage table in Embodiment 1. A main difference lies in that a storage platform 300 is located on a side of a connecting base 200.

Similarly, in this embodiment, when the storage platform 300 is connected to the connecting base 200, the storage platform 300 is connected to a side of the connecting base 200, to place items through the storage platform 300, thereby facilitating placement and taking of daily necessities. In addition, similarly, an electronic control unit in the connecting base 200 supplies power to the rotating component 400 to make the rotating component 400 work, thereby agitating liquid in a water lamp body 100 to make the liquid flow. Finally, when items are placed on the water lamp storage table, ornamental value can be improved, functionality of the water lamp storage table is enhanced, and interestingness of the water lamp storage table can be improved.

The foregoing shows and describes basic principles, main features of the disclosure and advantages of the disclosure. Any person skilled in the art can implement fluently the disclosure according to what is shown in the accompanying drawings of the specification and what is described above. However, some equivalent variations, modification and evolution to the above-disclosed technical content made by a person skilled in the art without departing from the scope of the technical solutions of the disclosure shall be equivalent embodiments of the disclosure. In addition, any equivalent variation, modification, and evolution made to the above embodiments according to the technical essence of the disclosure still fall within the protection scope of the technical solutions of the disclosure.

What is claimed is:

1. A water lamp storage table, comprising:
a water lamp body with a light transmissive three-dimensional shape, the water lamp body being filled with flowable liquid;
a connecting base connected to the water lamp body, an electronic control unit being disposed inside the connecting base;
a storage platform, connected to the water lamp body or the connecting base, and used for placing items; and
a rotating component, connected to the electronic control unit, and used for agitating the liquid inside the water lamp body for flowing.

2. The water lamp storage table according to claim 1, wherein when the storage platform is connected to the water lamp body, the connecting base is located at the bottom of the water lamp body, and the storage platform is located at the top of the water lamp body.

3. The water lamp storage table according to claim 1, wherein when the storage platform is connected to the connecting base, the storage platform is located on a side of the connecting base.

4. The water lamp storage table according to claim 2, wherein the storage platform has an accommodation portion with an opening facing upward or an opening facing a side.

5. The water lamp storage table according to claim 3, wherein the storage platform has an accommodation portion with an opening facing upward or an opening facing a side.

6. The water lamp storage table according to claim 4, wherein the water lamp body comprises a hollow housing and a bottom cover, and the bottom cover covers the bottom of the hollow housing, so that an enclosed space is formed inside the hollow housing, and the enclosed space is filled with the flowable liquid.

7. The water lamp storage table according to claim 5, wherein the water lamp body comprises a hollow housing and a bottom cover, and the bottom cover covers the bottom of the hollow housing, so that an enclosed space is formed inside the hollow housing, and the enclosed space is filled with the flowable liquid.

8. The water lamp storage table according to claim 6, wherein the rotating component comprises a magnetic moving member, a magnetic rotating shaft, and a power member, the magnetic moving member is disposed in the enclosed space and located at the bottom of the water lamp body, the magnetic rotating shaft and the power member are connected to each other and are separately located in the connecting base, and the power member is electrically connected to the electronic control unit; and
the power member drives the magnetic rotating shaft to rotate, and under a rotating state of the magnetic rotating shaft, the magnetic moving member rotates after being adsorbed by the magnetic rotating shaft, to agitate the liquid in the enclosed space to make the liquid flow.

9. The water lamp storage table according to claim 7, wherein the rotating component comprises a magnetic moving member, a magnetic rotating shaft, and a power member, the magnetic moving member is disposed in the enclosed space and located at the bottom of the water lamp body, the magnetic rotating shaft and the power member are connected to each other and are separately located in the connecting base, and the power member is electrically connected to the electronic control unit; and
the power member drives the magnetic rotating shaft to rotate, and under a rotating state of the magnetic rotating shaft, the magnetic moving member rotates after being adsorbed by the magnetic rotating shaft, to agitate the liquid in the enclosed space to make the liquid flow.

10. The water lamp storage table according to claim 1, wherein a light emitting unit is further disposed in the connecting base, and is electrically connected to the electronic control unit.

11. The water lamp storage table according to claim 1, wherein the connecting base has a switch electrically connected to the electronic control unit.

12. The water lamp storage table according to claim 1, wherein glittering powders are added into the flowable liquid.
